(19) United States
(12) Patent Application Publication
(10) Pub. No.: US 2016/0066150 A1
(43) Pub. Date: Mar. 3, 2016

(54) Dynamic Configuration of a Positioning System

(71) Applicant: QUALCOMM Incorporated, San Diego, CA (US)

(72) Inventors: Hui Chao, San Jose, CA (US); Yin Chen, Campbell, CA (US); Jiajian Chen, San Jose, CA (US)

(21) Appl. No.: 14/472,117

(22) Filed: Aug. 28, 2014

(51) Int. Cl. H04W 4/02; H04W 24/10; H04W 4/00

(52) U.S. Cl. CPC H04W 4/025; H04W 4/005; H04W 24/10

(57) ABSTRACT

Methods and apparatuses of configuring positioning estimations dynamically are disclosed. According to aspects of the present disclosure, the method may include receiving one or more user interface inputs and one or more sensor measurements at a mobile device, determining an intention score of a user according to the one or more user interface inputs and the one or more sensor measurements, selecting a positioning estimation scheme from a plurality of positioning estimation schemes based at least in part on the intention score of the user, and generating a positioning estimation at the mobile device using the positioning estimation scheme selected.

### FIELD

The present disclosure relates to the field of wireless communications. In particular, the present disclosure relates to methods and apparatuses for configuring positioning estimations dynamically.

### BACKGROUND

Different workflows or approaches may be employed to estimate a user position. Each approach has different bandwidth and computation requirements and costs. A position estimation engine may try to balance the accuracy with the cost. For example, high accuracy may be desired, but obtaining high accuracy may require more communication bandwidth, higher computational intensity and therefore more heat generated on a mobile device. Similarly, more frequent position updates may produce more accurate results, but such frequent position updates may use more computational resources. Often, different applications can have different accuracy requirements for positioning estimation. For example, for certain location based services (such as broadcasting advertisements), a positioning estimation error of 50 meters may be tolerated. However, for an indoor environment pedestrian navigation application, it may only tolerate a positioning estimation error of 5 meters or less.

Thus, different circumstances may require different positioning estimations. In other words, a desired result may depend on a user's intention. Accordingly, it is beneficial to have methods and apparatus that can dynamically choose the most appropriate algorithm or processing flow for positioning estimation, based the user's intention.

### SUMMARY

Methods and apparatuses for configuring positioning estimations dynamically are disclosed. In one embodiment, a method of configuring positioning estimations dynamically may include receiving one or more user interface inputs and one or more sensor measurements at a mobile device; determining an intention score of a user according to the one or more user interface inputs and the one or more sensor measurements; selecting a positioning estimation scheme from a plurality of positioning estimation schemes based at least in part on the intention score of the user; and generating a positioning estimation at the mobile device using the positioning estimation scheme selected.

In another embodiment, an apparatus for configuring positioning estimations dynamically may include one or more user input mechanisms, one or more sensors, and one or more processors to: receive one or more user interface inputs via the one or more user input mechanisms, receive one or more sensor measurements from the one or more sensors, determine an intention score of a user according to the one or more user interface inputs and the one or more sensor measurements, select a positioning estimation scheme from a plurality of positioning estimation schemes based, at least in part, on the intention score of the user, and generate a positioning estimation at the apparatus using the positioning estimation scheme selected.

In yet another embodiment, a computer program product includes non-transitory medium storing instructions for execution by one or more computer systems. The instructions comprises instructions for receiving one or more user interface inputs and one or more sensor measurements at a mobile device; instructions for determining an intention score of a user according to the one or more user interface inputs and the one or more sensor measurements; instructions for selecting a positioning estimation scheme from a plurality of positioning estimation schemes based at least in part on the intention score of the user; and instructions for generating a positioning estimation at the mobile device using the positioning estimation scheme selected.

### BRIEF DESCRIPTION OF THE DRAWINGS

The aforementioned features and advantages of the disclosure, as well as additional features and advantages thereof, will be more clearly understandable after reading detailed descriptions of embodiments of the disclosure in conjunction with the non-limiting and non-exhaustive aspects of following drawings. Like numbers are used throughout the figures.

FIG. 1 illustrates an exemplary method of configuring positioning estimations dynamically according to aspects of the present disclosure.

FIG. 2A illustrates a method of determining a relative positioning estimation of a mobile device according to aspects of the present disclosure.

FIG. 2B illustrates a method of determining an absolute positioning estimation of a mobile device according to aspects of the present disclosure.

FIG. 3A illustrates direction of motion and orientation of a mobile device according to some aspects of the present disclosure.

FIG. 3B illustrates a side view of the mobile device of FIG. 3A.

FIG. 4A illustrates a method of tracking a user's motion according to aspects of the present disclosure.

FIG. 4B illustrates a comparison of signal vector magnitude between motions of walking versus non-walking according to aspects of the present disclosure.

FIG. 5 illustrates an exemplary apparatus for configuring positioning estimations dynamically according to aspects of the present disclosure.

FIG. 6A illustrates an exemplary flow chart for implementing methods of configuring positioning estimations dynamically according to aspects of the present disclosure.

FIG. 6B illustrates an exemplary implementation for determining an intention score of a user according to aspects of the present disclosure.

FIG. 6C illustrates an exemplary implementation for selecting a positioning estimation scheme according to aspects of the present disclosure.

FIG. 6D illustrates another exemplary implementation for configuring positioning estimations dynamically according to aspects of the present disclosure.

FIG. 7 illustrates an exemplary block diagram of a mobile device according to aspects of the present disclosure.

### DESCRIPTION OF EMBODIMENTS

Embodiments of configuring positioning estimations dynamically are disclosed. The following descriptions are presented to enable any person skilled in the art to make and use the disclosure. Descriptions of specific embodiments and applications are provided only as examples. Various modifications and combinations of the examples described herein will be readily apparent to those skilled in the art, and the general principles defined herein may be applied to other examples and applications without departing from the scope of the disclosure. Thus, the present disclosure is not intended to be limited to the examples described and shown, but is to be accorded the scope consistent with the principles and features disclosed herein. The word “exemplary” or “example” is used herein to mean “serving as an example, instance, or illustration.” Any aspect or embodiment described herein as “exemplary” or as an “example” in not necessarily to be construed as preferred or advantageous over other aspects or embodiments.

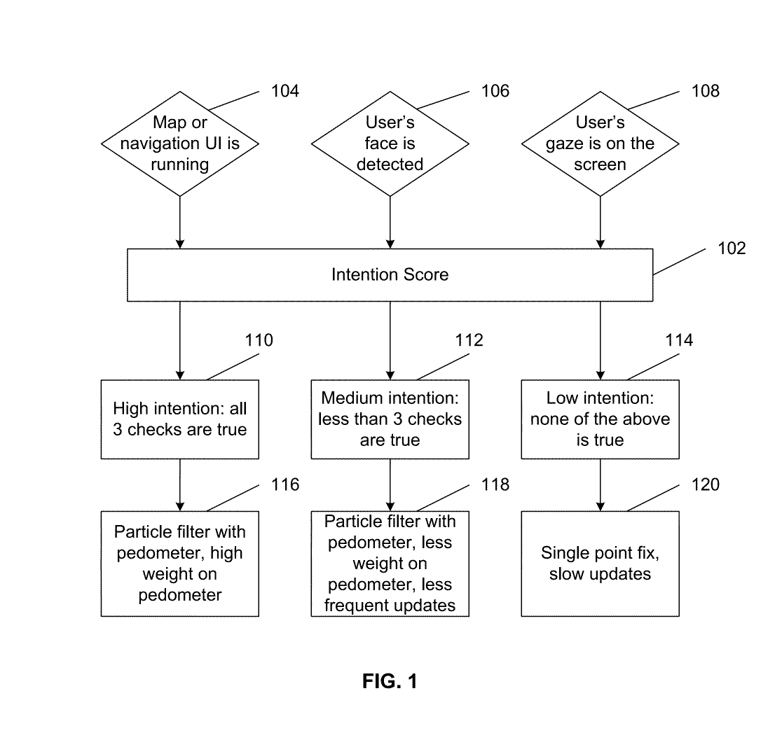

FIG. 1 illustrates an exemplary method of configuring positioning estimations dynamically according to aspects of the present disclosure. In the example shown in FIG. 1, an intention score 102 of a user may be inferred based on captured attention. According to aspects of the present disclosure, a user's attention may be captured from a number of inputs. One input can be based on whether the user interface is running a map or navigation application as shown in block 104. For example, if the screen of a mobile device is displaying a map and the screen is active, it strongly implies that the user cares about accuracy of the positioning estimation at the moment. Another input can be based on whether the user's face is detected as shown in block 106. Yet another input can be based on whether the user is looking at the screen and/or gazing at the screen as shown in block 108. Attention of the user can be inferred from the detection of a user's face and/or gaze. A front camera, even with low power, low resolution, can be used to capture a user's face and/or the user's gaze (i.e., the user's eyes are staring at the screen).

Based on user attention, different positioning estimation workflows may be chosen based on the inputs from block 104, block 106, and block 108. In some embodiments, a high intention score may be inferred when the three checks in blocks 104, 106, and 108 are true, as shown in block 110; a medium intention score may be inferred when less than three checks in blocks 104, 106, and 108 are true, as shown in block 112; and a low intention score may be inferred when none of the three checks in blocks 104, 106, and 108 are true, as shown in block 114.

According to aspects of the present disclosure, different positioning estimation schemes may be employed dynamically based on the intention score of the user. A positioning estimation may be generated at the mobile device using the positioning estimation scheme selected. In some implementations, in the case of a high user intention score, a positioning estimation scheme using a particle filter with a pedometer may be selected, as shown in block 116. In this exemplary implementation, more weight (for example 80%) of the positioning estimation may be placed on the information obtained from the pedometer.

In the case of a medium user intention score, a positioning estimation scheme using a particle filter with a pedometer may still be selected, as shown in block 118. In this exemplary implementation, less weight (for example 60%) of the positioning estimation may be placed on the information obtained from the pedometer, and less frequent updates of the positioning estimation may be implemented.

In the case of a low user intention score, a positioning estimation scheme using single point fix may be selected, as shown in block 120. In this exemplary implementation, even less frequent updates of the positioning estimation than the case of medium user intention score may be implemented.

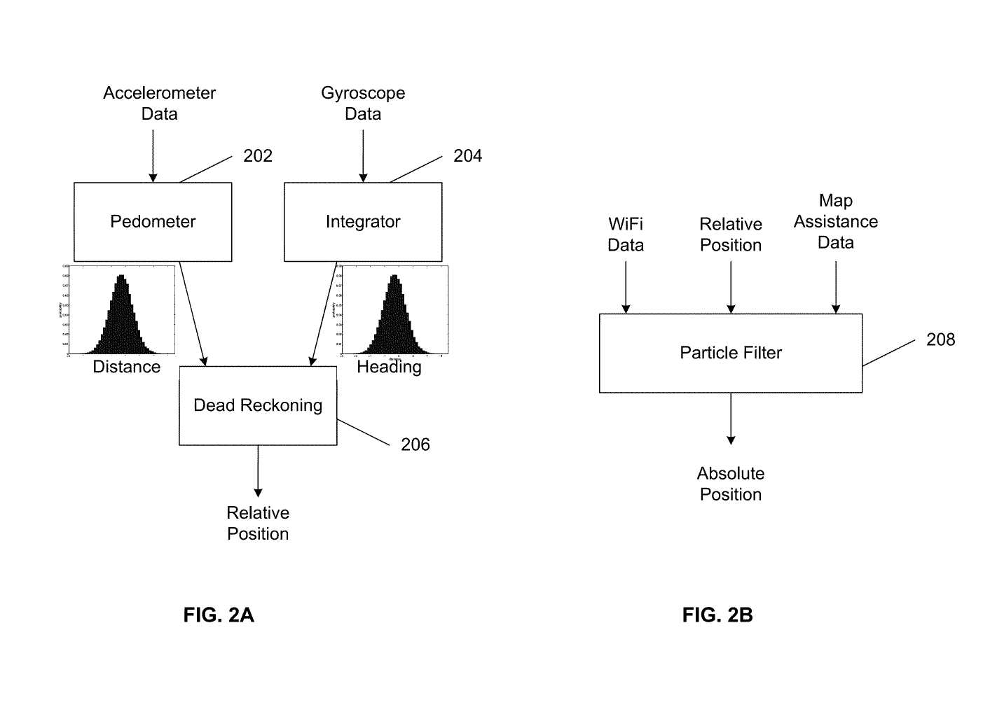

FIG. 2A illustrates a method of determining a relative positioning estimation of a mobile device according to aspects of the present disclosure. In the exemplary method shown in FIG. 2A, accelerometer data that provides information about distance travelled may be collected by a pedometer 202. Similarly, gyroscope data that provides information about heading of the user may be collected by an integrator 204. Then, taking the information gathered by the pedometer 202 and integrator 204, a process of deduced reckoning (also referred to dead reckoning) as shown in block 206 may be applied to determine a relative positioning estimation of the mobile device.

FIG. 2B illustrates a method of determining an absolute positioning estimation of a mobile device according to aspects of the present disclosure. As shown in FIG. 2B, a particle filter 208 may be employed to determine an absolute positioning estimation of a mobile device, using inputs from WiFi data, relative positioning estimation as described in FIG. 2A, map assistance data, and/or combination thereof.

According to aspects of the present disclosure, a determination that a user is highly attentive to the map or a determination that a navigation user interface program is running on the screen may indicate that the user may be holding the mobile device steadily. In this case, information collected by the inertial measurement unit may be highly valuable for positioning estimation.

As shown in FIG. 2A and FIG. 2B, positioning estimation can be performed based on WiFi measurements and pedometer measurements. In some cases, the pedometer measurements can be useful if it is determined that the user is holding the mobile device steadily and reading the information displayed on the mobile device. Note that WiFi scanning can be expensive in terms of power consumption. A less frequent positioning update can lead to a lower power usage. In some implementations, WiFi based positioning estimations can have two different modes. In a high fidelity mode, particle filter based positioning estimation may be employed, which uses heatmap of access points and other assistance data, and this scheme may be relatively more expensive. In a low power mode, ranging and/or single point fix based positioning estimations may be employed, which only uses access point location, and this scheme can be relatively cheaper.

According to aspects of the present disclosure, a pedometer can be integrated into WiFi based positioning with different weights depending on sensor fidelity. In some situations, if it is detected that the user is holding the mobile device (which includes the pedometer) steadily, heavier weights can be put on the pedometer information. If it is detected that the mobile device is in a swinging purse, the pedometer information can be much less reliable and less weight can be put on it.

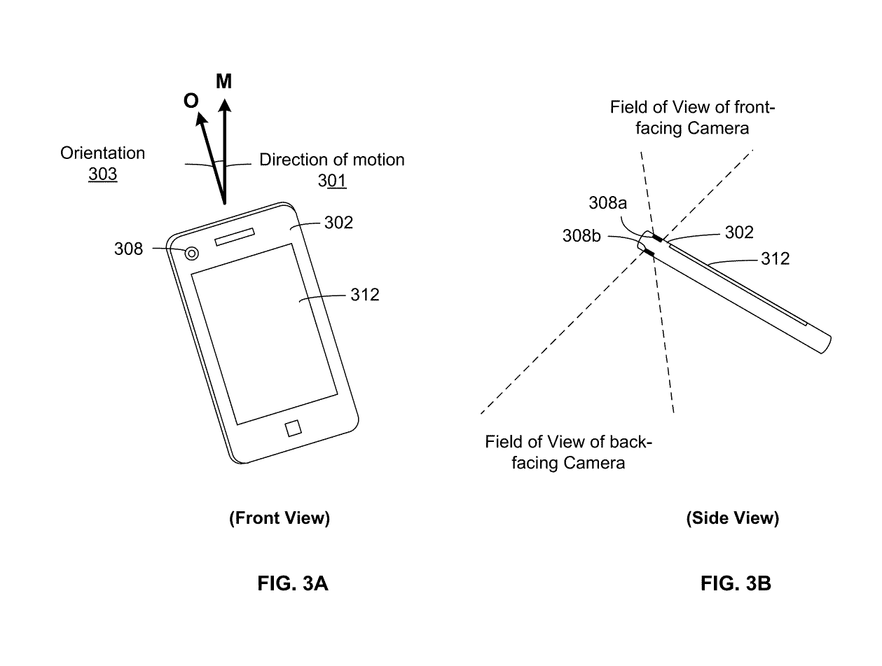

FIG. 3A illustrates direction of motion and orientation of a mobile device according to some aspects of the present disclosure. In the example shown in FIG. 3A, in some use cases, direction of motion 301 of a mobile device 302 may be different from the mobile device orientation 303. The mobile device may include one or more camera 308 and a display 312.

According to aspects of the present disclosure, when the mobile device 302 is in pedestrian navigation mode, one or more cameras 308 of the mobile device 302 may be configured to capture image frames for assisting in the determination of a user's intention score, such as determining whether the user's face is detected and/or whether the user is gazing on the screen, as described in association with FIG. 1. In addition, the image frames may be used for assisting in the determination of a positioning estimation of the user device. The image captured may be shown to a user in display 312.

FIG. 3B illustrates a side view of the mobile device 302 of FIG. 3A. In one approach, the mobile device 302 may be configured to use either the front camera 308a (located in the front side of the mobile device) or the back camera 308b (located in the back side of the mobile device) to capture image frames. For example, as shown in FIG. 3B, the front camera 308a can be configured to capture the field of view of an area above the mobile device 302, and the back camera 308b can be configured to capture the field of view of an area below the mobile device 302. In another approach, the mobile device 302 may be configured to use both the front camera 308a and the back camera 308b to capture image frames in both front view and back view of the mobile device 302. With this approach, in some venues, features on the floor or on the ceiling may be gathered to estimate the direction of motion of the mobile device 302 with respect to the mobile device orientation 303.

In yet another approach, both of the front camera 308a and the back camera 308b may be used in parallel. In this approach, errors caused by the two different perspectives in the front camera 308a and the back camera 308b may have opposite signs and may be compensated because perspectives of the front camera 308a and the back camera 308b are oriented 180 degrees apart from each other. In yet another approach, either camera may be chosen based on which field of view has more features which are easier to track and based on which field of view has fewer moving objects.

There are numerous criteria may be used in choosing the front camera 308a over the back camera 308b, or vice versa, including but not limited to: 1) which field of view gives more features; 2) which field of view are easier to track; and 3) which field of view has fewer moving objects. A camera may be chosen based on which one gives a higher average confidence metric for face detection, gaze detection, and/or feature tracking In addition, according to aspects of the present disclosure, the decision of which camera to track can be made adaptively since the environment of the mobile device 302 may change while it is being held by a user. In addition, according to aspects of the present disclosure, the mobile device 302 may be configured to use metrics to reject outliers since the image frames might contain features of moving parts. For example, one source of such moving parts may be the feet of the user.

According to aspects of the present disclosure, in determining whether the user's face is detected and/or whether the user is looking or gazing on the screen, the mobile device can be configured to identify and track the features in the image frames. In some embodiments, identifying and tracking features in image frames may be performed using a number of techniques. In one approach, a method of identifying features may be performed by examining the minimum eigenvalue of each 2 by 2 gradient matrix. Then the features are tracked using a Newton-Raphson method of minimizing the difference between the two windows. The method of multi-resolution tracking allows for relatively large displacements between images. Note that during tracking of features from one frame to the next frame, errors may accumulate. To detect potentially bad features, the mobile device 302 may be configured to monitor whether the image signal in the window around the feature in the current frame is still similar to the image signal around the feature in the previous frame. Since features may be tracked over many frames, the image content may be deformed. To address this issue, a consistency check may be performed with a similarity or an affine mapping.

According to aspects of the present disclosure, to identify an object, such as the face of a user in an image, points on the object may be extracted to provide feature descriptions (also referred to as keypoints, feature points or features for short) of the object. This description, extracted from a training image, may then be used to identify the object when attempting to locate the object in a test image containing many other objects. To perform reliable recognition, the features extracted from the training image may be detectable even under changes in image scale, noise and illumination. Such points usually lie on high-contrast regions of the image, such as object edges.

Another characteristic of these features is that the relative positions between them in the original scene may not change from one image to another. For example, if only the four corners of a door are used as features, they may work regardless of the door's position; but if points in the frame are used, the recognition may fail if the door is opened or closed. Similarly, features located in articulated or flexible objects may typically not work if any change in their internal geometry happens between two images in the set being processed. In some implementations, scale-invariant feature transform (SIFT) detects and uses a larger number of features from the images, which can reduce the contribution of the errors caused by the local variations in the average error of all feature matching errors. Thus, the disclosed method may identify objects even among clutter and under partial occlusion; because the SIFT feature descriptor can be invariant to uniform scaling, orientation, and partially invariant to affine distortion and illumination changes.

For example, keypoints of an object may first be extracted from a set of reference images and stored in a database. An object is recognized in a new image by comparing each feature from the new image to this database and finding candidate matching features based on Euclidean distance of their feature vectors. From the full set of matches, subsets of keypoints that agree on the object and its location, scale, and orientation in the new image may be identified to filter out good matches. The determination of consistent clusters may be performed by using a hash table implementation of a generalized Hough transform. Each cluster of 3 or more features that agree on an object and its pose may then be subject to further detailed model verification and subsequently outliers may be discarded. The probability that a particular set of features indicates the presence of an object may then be computed based on the accuracy of fit and number of probable false matches. Object matches that pass the tests can be identified as correct with high confidence.

According to aspects of the present disclosure, image feature generation transforms an image into a large collection of feature vectors, each of which may be invariant to image translation, scaling, and rotation, as well as invariant to illumination changes and robust to local geometric distortion. These features share similar properties with neurons in inferior temporal cortex that are used for object recognition in primate vision. Key locations may be defined as maxima and minima of the result of difference of Gaussians function applied in scale space to a series of smoothed and resampled images. Low contrast candidate points and edge response points along an edge may be discarded. Dominant orientations are assigned to localized keypoints. This approach ensures that the keypoints are more stable for matching and recognition. SIFT descriptors robust to local affine distortion may then be obtained by considering pixels around a radius of the key location, blurring and resampling of local image orientation planes.

Features matching and indexing may include storing SIFT keys and identifying matching keys from the new image. In one approach, a modification of the k-d tree algorithm which is also referred to as the best-bin-first search method that may be used to identify the nearest neighbors with high probability using a limited amount of computation. The best-bin-first algorithm uses a modified search ordering for the k-d tree algorithm so that bins in feature space may be searched in the order of their closest distance from the query location. This search order requires the use of a heap-based priority queue for efficient determination of the search order. The best candidate match for each keypoint may be found by identifying its nearest neighbor in the database of keypoints from training images. The nearest neighbors can be defined as the keypoints with minimum Euclidean distance from the given descriptor vector. The probability that a match is correct can be determined by taking the ratio of distance from the closest neighbor to the distance of the second closest.

In one exemplary implementation, matches in which the distance ratio is greater than 0.8 may be rejected, which eliminates 90% of the false matches while discarding less than 5% of the correct matches. To further improve the efficiency of the best-bin-first algorithm, search may be cut off after checking a predetermined number (for example 100) nearest neighbor candidates. For a database of 100,000 keypoints, this may provide a speedup over exact nearest neighbor search by about 2 orders of magnitude, yet results in less than a 5% loss in the number of correct matches.

Note that with the exemplary implementation, the Hough Transform may be used to cluster reliable model hypotheses to search for keys that agree upon a particular model pose. Hough transform may be used to identify clusters of features with a consistent interpretation by using each feature to vote for object poses that may be consistent with the feature. When clusters of features are found to vote for the same pose of an object, the probability of the interpretation being correct may be higher than for any single feature. An entry in a hash table may be created to predict the model location, orientation, and scale from the match hypothesis. The hash table can be searched to identify clusters of at least 3 entries in a bin, and the bins may be sorted into decreasing order of size.

According to aspects of the present disclosure, each of the SIFT keypoints may specify 2D location, scale, and orientation. In addition, each matched keypoint in the database may have a record of its parameters relative to the training image in which it is found. The similarity transform implied by these 4 parameters may be an approximation to the 6 degree-of-freedom pose space for a 3D object and also does not account for any non-rigid deformations. Therefore, an exemplary implementation may use broad bin sizes of 30 degrees for orientation, a factor of 2 for scale, and 0.2 times the maximum projected training image dimension (using the predicted scale) for location. The SIFT key samples generated at the larger scale may be given twice the weight of those at the smaller scale. With this approach, the larger scale may in effect able to filter the most likely neighbors for checking at the smaller scale. This approach also improves recognition performance by giving more weight to the least-noisy scale. According to aspects of the present disclosure, to avoid the issue of boundary effects in bin assignment, each keypoint match may vote for the 2 closest bins in each dimension, giving a total of 16 entries for each hypothesis and further broadening the pose range.

According to aspects of the present disclosure, outliers may be removed by checking for agreement between each image feature and the model, for a given parameter solution. For example, given a linear least squares solution, each match may be required to agree within half the error range that is used for the parameters in the Hough transform bins. As outliers are discarded, the linear least squares solution may be resolved with the remaining points, and the process may be iterated. In some implementations, if less than a predetermined number of points (e.g. 3 points) remain after discarding outliers, the match may be rejected. In addition, a top-down matching phase may be used to add any further matches that agree with the projected model position, which may have been missed from the Hough transform bin due to the similarity transform approximation or other errors.

The decision to accept or reject a model hypothesis can be based on a detailed probabilistic model. The method first computes an expected number of false matches to the model pose, given the projected size of the model, the number of features within the region, and the accuracy of the fit. A Bayesian probability analysis can then give the probability that the object may be present based on the actual number of matching features found. A model may be accepted if the final probability for a correct interpretation is greater than a predetermined percentage (for example 95%).

According to aspects of the present disclosure, in one approach, rotation invariant feature transform (RIFT) method may be employed as a rotation-invariant generalization of SIFT to address under clutter or partial occlusion situations. The RIFT descriptor may be constructed using circular normalized patches divided into concentric rings of equal width and within each ring a gradient orientation histogram may be computed. To maintain rotation invariance, the orientation may be measured at each point relative to the direction pointing outward from the center.

In another approach, a generalized robust invariant feature (G-RIF) method may be used. The G-RIF encodes edge orientation, edge density and hue information in a unified form combining perceptual information with spatial encoding. The object recognition scheme uses neighboring context based voting to estimate object models.

In yet another approach, a speeded up robust feature (SURF) method may be used which uses a scale and rotation-invariant interest point detector/descriptor that can outperform previously proposed schemes with respect to repeatability, distinctiveness, and robustness. SURF relies on integral images for image convolutions to reduce computation time, and builds on the strengths of the leading existing detectors and descriptors (using a fast Hessian matrix-based measure for the detector and a distribution-based descriptor). The SURF method describes a distribution of Haar wavelet responses within the interest point neighborhood. Integral images may be used for speed, and 64 dimensions may be used to reduce the time for feature computation and matching. The indexing step may be based on the sign of the Laplacian, which increases the matching speed and the robustness of the descriptor.

In yet another approach, the principle component analysis SIFT (PCA-SIFT) method may be used. In some implementations, the PCA-SIFT descriptor is a vector of image gradients in x and y direction computed within the support region. The gradient region can be sampled at 39×39 locations. Thus, the vector can be of dimension 3042. The dimension can be reduced to 36 with PCA. In yet another approach, the Gradient location-orientation histogram (GLOH) method can be employed, which is an extension of the SIFT descriptor designed to increase its robustness and distinctiveness. In some implementations, the SIFT descriptor can be computed for a log-polar location grid with three bins in radial direction (the radius set to 6, 11, and 15) and 8 in angular direction, which results in 17 location bins. The central bin is not divided in angular directions. The gradient orientations may be quantized in 16 bins resulting in 272 bin histogram. The size of this descriptor can be reduced with PCA. The covariance matrix for PCA can be estimated on image patches collected from various images. The 128 largest eigenvectors may then be used for description.

In yet another approach, a two-object recognition algorithm may be employed to use with the limitations of current mobile devices. In contrast to the classic SIFT approach, the Features from Accelerated Segment Test (FAST) corner detector can be used for feature detection. This approach distinguishes between the off-line preparation phase where features may be created at different scale levels and the on-line phase where features may be created at a current fixed scale level of the mobile device's camera image. In one exemplary implementation, features may be created from a predetermined fixed patch size (for example 15×15 pixels) and form a SIFT descriptor with 36 dimensions. The approach can be further extended by integrating a Scalable Vocabulary Tree in the recognition pipeline. This allows an efficient recognition of a larger number of objects on mobile devices.

According to aspects of the present disclosure, the detection and description of local image features can help in object recognition. The SIFT features can be local and based on the appearance of the object at particular interest points, and may be invariant to image scale and rotation. They may also be robust to changes in illumination, noise, and minor changes in viewpoint. In addition to these properties, the features may be highly distinctive, relatively easy to extract and allow for correct object identification with low probability of mismatch. The features can be relatively easy to match against a (large) database of local features, and generally probabilistic algorithms such as k-dimensional (k-d) trees with best-bin-first search may be used. Object descriptions by a set of SIFT features may also be robust to partial occlusion. For example, as few as 3 SIFT features from an object may be sufficient to compute its location and pose. In some implementations, recognition may be performed in quasi real time, for small databases and on modern computer hardware.

According to aspects of the present disclosure, the random sample consensus (RANSAC) technique may be employed to remove outliers caused by moving objects in view of the camera. Note that the RANSAC uses an iterative method to estimate parameters of a mathematical model from a set of observed data which contains outliers. This method is a non-deterministic as it produces a reasonable result with an associated probability, where the probability may increase as more iteration is performed.

In one exemplary implementation, a set of observed data values, a parameterized model which can be fitted to the observations with corresponding confidence parameters. In this exemplary implementation, the method iteratively selects a random subset of the original data. These data can be hypothetical inliers and these hypotheses may then be tested as follows:
1. A model is fitted to the hypothetical inliers, i.e. all free parameters of the model are reconstructed from the inliers.
2. All other data are then tested against the fitted model and, if a point fits well to the estimated model; it is considered as a hypothetical inlier.
3. The estimated model can be considered acceptable if sufficiently number of points have been classified as hypothetical inliers.
4. The model is re-estimated from all hypothetical inliers, because it has only been estimated from the initial set of hypothetical inliers.
5. Finally, the model is evaluated by estimating the error of the inliers relative to the model.

The above procedure can be repeated for a predetermined number of times, each time producing either a model which may be rejected because too few points are classified as inliers or a refined model together with a corresponding error measure. In the latter case, the refined model is kept if the error is lower than the previously saved model.

In another exemplary implementation, moving objects in view of the camera can be actively identified and removed using a model based motion tracking method. In one approach, the objective of tracking can be treated as a problem of model recognition. A binary representation of the target can be tracked, and a Hausdorff distance based search is used to search regions of the image for the object. For a binary representation of the target (a model), output from the standard canny edge detector of the Gaussian smoothed image is augmented with the notion of a model history. At each frame, a Hausdorff search can be performed on each target, using the canny edges from the current image and the current model. In addition, an affine estimation may be performed to approximate the net background motion. From the results of these two searches, information can be gathered about the target, and be used to approximate the motion of the target, as well as separate the background from motion in the region of the target. To be able to handle hazard/unusual conditions (such as the object becoming occluded going into a shadow, the object leaving the frame, or camera image distortion providing bad image quality), history data about the target may be retained, such as the target's past motion and size change, characteristic views of the target (snapshots throughout time that provide an accurate representation of the different ways the target has been tracked), and match qualities in the past.

The history of tracking the target can be useful in more than just aiding hazard/unusual conditions; that part of a solid motion tracking method can involve history data, and not just a frame by frame method of motion comparison. This history state can provide information regarding how to decide what should be considered part of the target (e.g. things moving close to the object moving at the same speed should be incorporated into the object), and with information about motion and size, the method can predictively estimate where a lost object may have gone, or where it might reappear (which has been useful in recovering targets that leave the frame and reappear later in time).

An inherent challenge in the motion tracking method may be caused by the fact that the camera can have an arbitrary movement (as opposed to a stationary camera), which makes developing a tracking system that can handle unpredictable changes in camera motion difficult. A computationally efficient affine background estimation scheme may be used to provide information as to the motion of the camera and scene.

According to aspects of the present disclosure, an affine transformation for the image can be performed at time t to the image at time t+dt, which allows correlating the motion in the two images. This background information allows the method to synthesize an image at time t+dt from the image at time t and the affine transform that can be an approximation of the net scene motion. This synthesized image can be useful in generating new model information and removing background clutter from the model space, because a difference of the actual image at t+dt and the generated image at t+dt can be taken to remove image features from the space surrounding targets.

In addition to the use of the affine transform as a tool to clean-up the search space, it is also used to normalize the coordinate movement of the targets: by having a vector to track how the background may be moving, and a vector to track how the target may be moving, a difference of the two vector may be taken to generate a vector that describes the motion of the target with respect to the background. This vector allows the method to predictively match where the target should be, and anticipate hazard conditions (for example looking ahead in the direction of the motion can provide clues about upcoming obstacles, as well as keeping track of where the object may be in case of a hazard condition. When an object enters a hazard condition, the method may still be able to estimate the background motion, and use that coupled with the knowledge of the model's previous movements to guess where the model may reappear, or re-enter the frame.

The background estimation has been a key factor in the prolonged tracking of objects. Note that short term tracking may be performed without background estimation, but after a period of time, object distortion and hazards may be difficult to cope with effectively without a good estimation of the background.

According to aspects of the present disclosure, one of the advantages of using the Hausdorff distance as a matching operator is that it can be quite tolerant of changes in shape during matching, but using the Hausdorff distance as a matching operator may require the objects being tracked be more accurately defined.

In one approach, straight dilation-based methods of grabbing a new model from the time t+1 image can be used. Note that in some situations where there are non-object features close to the object (which occurs quite often), the dilation method may not be effective because it may slowly incorporate the entire scene into the model. Thus, a method of updating the model from frame to frame that can be tolerant to changes in the model shape, but not so relaxed that causing incorporating non-model pixels into the model may be adopted. One exemplary implementation is to use a combination of background removal and adding the previous models to the current model match window and taking what seems to be stable pixels, as well as the new ones surrounding them, which over time may either get eliminated from the model because they may not be stable, or get incorporated into the model. This approach has been effective in keeping the models relatively clean from clutter in the image. For example, with this approach, no longer does a road close to a truck get pulled into the model pixel by pixel. Note that the models may appear to be dilated, but this may be a result of the history effect of how the models are constructed, but it may also have the feature of making the search results more definite because this method can have more model pixels to possibly match in the next frame.

Note that at each frame, there may be a significant amount of computation to be performed. According to some implementations, the mobile device can be configured to perform smoothing/feature extraction, Hausdorff matching each target (for example one match per model), as well as affine background estimation. Each of these operations can be quite computationally expensive individually. In order to achieve real-time performance on a mobile device, the design can be configured to use as much parallelism as possible.

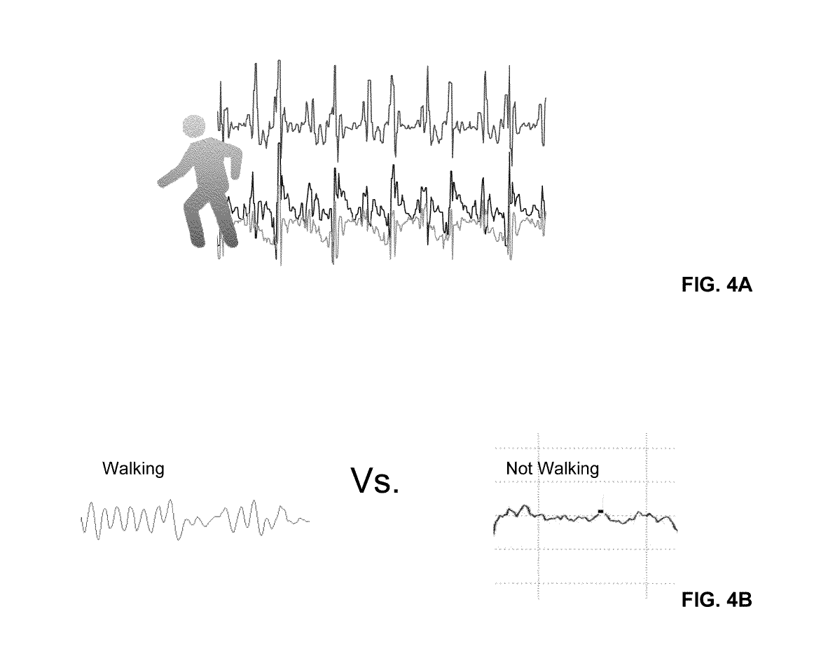

FIG. 4A illustrates a method of tracking a user's motion according to aspects of the present disclosure. Various sensors, including but not limited to accelerometer, gyroscope, and magnetometer may be used to track a user's motion. According to embodiments of the present disclosure, an accelerometer can be a device that measures the acceleration of the mobile device 302. It can be configured to measure the acceleration associated with the weight experienced by a test mass that resides in the frame of reference of the accelerometer. For example, an accelerometer measures a value even if it is stationary, because masses have weights, even though there is no change of velocity. The accelerometer measures weight per unit of mass, a quantity also known as gravitational force or g-force. In other words, by measuring weight, an accelerometer measures the acceleration of the free-fall reference frame (inertial reference frame) relative to itself. In one approach, a multi-axis accelerometer can be used to detect magnitude and direction of the proper acceleration (or g-force), as a vector quantity. In addition, the multi-axis accelerometer can be used to sense orientation as the direction of weight changes, coordinate acceleration as it produces g-force or a change in g-force, vibration, and shock. In another approach, a micro-machined accelerometer can be used to detect position, movement, and orientation of the mobile device 302.

In some embodiments, the acceleration in three axis can be considered. Movement classifications can be performed by evaluating consecutive peaks in the signal vector magnitude (SVM): SVM i=xi²+yi²+zi²; where xi is the i^{th} sample of the x-axis signal, yi is the i^{th} sample of the y-axis signal, zi is the i^{th} sample of the z-axis signal. In some implementations, z may be normalized by subtracting the standard gravity vector (9.80665 m/ŝ̂2).

FIG. 4B illustrates a comparison of signal vector magnitude between motions of walking versus non-walking according to aspects of the present disclosure. As shown in FIG. 4B, SVM from a steady walk with the mobile device being held steadily tends to have regular peaks, as shown on the left hand side of FIG. 4B; while other non-walking movements tend to have noisy and unclear peaks, as shown on the right hand side of FIG. 4B.

According to aspects of the present disclosure, the mobile device 302 may include a motion direction tracking module and an alignment angle computation module (not shown). The motion direction tracking module and the alignment angle computation module can operate based on sensor data, information obtained from a pedometer, etc., to determine the misalignment angle associated with movement of a mobile device 302 being carried by a pedestrian. Initially, based on data collected from accelerometer(s) and/or the pedometer, pedestrian steps can be identified and the direction of gravity relative to the sensor axes of the mobile device 302 can be determined. These initial computations form a basis for the operation of the motion direction tracking module and the alignment angle computation module, as described below.

Referring to FIG. 4A, with regard to pedestrian motion, such as walking, running, etc., the direction of motion changes within a given pedestrian step and between consecutive steps based on the biomechanics of pedestrian motion. For example, rather than proceeding in a constant forward direction, a moving pedestrian shifts left to right (e.g., left during a step with the left foot and right during a step with the right foot) with successive steps and vertically (e.g., up and down) within each step. Accordingly, transverse (lateral) acceleration associated with a series of pedestrian steps cycles between left and right with a two-step period while forward and vertical acceleration cycle with a one-step period.

According to aspects of the present disclosure, the motion direction tracking module may include a step shifter, a step summation module and a step correlation module (not shown). The motion direction tracking module can leverage the above properties of pedestrian motion to isolate the forward component of motion from the vertical and transverse components. For example, the motion direction tracking module records acceleration information obtained from accelerometer(s) (e.g., in a buffer) over consecutive steps. To rectify forward acceleration and suppress or cancel the transverse component of the acceleration, the motion direction tracking module utilizes the step shifter and the step summation module to sum odd and even steps. In other words, the step shifter shifts acceleration data corresponding to a series of pedestrian steps in time by one step. Subsequently, the step summation module sums the original acceleration information with the shifted acceleration information. As noted above, transverse changes sign with consecutive steps with a two-step period due to body rotation and rolling while forward and vertical acceleration exhibit a one-step period. As a result, summing pedestrian steps after a one-step shift reduces transverse acceleration while having minimal impact on vertical or forward acceleration.

If the mobile device 302 is not centrally positioned on a pedestrian's body or shifts orientation during the pedestrian motion, transverse acceleration may not be symmetrical from step to step. Accordingly, while the step shifter and step summation module operate to reduce the transverse component of acceleration, these modules may not substantially eliminate the transverse acceleration. To enhance the removal of transverse acceleration, the step correlation module can further operate on the acceleration data obtained from the accelerometer(s).

As a pedestrian steps forward (e.g., when walking), the center of gravity of the pedestrian moves up at the beginning of the step and down at the end of the step. Similarly, the forward speed of the pedestrian may decrease when the foot of the pedestrian reaches the ground at the end of a step; and the forward speed of the pedestrian may increase during the step. This relationship between forward and vertical motion during the progression of a pedestrian step may be leveraged by the step correlation module in further canceling transverse acceleration. In particular, if the acceleration associated with a pedestrian step is viewed as a periodic function, it can be observed that the vertical acceleration and forward acceleration associated with the step are offset by approximately a quarter of a step (e.g., 90 degrees). Accordingly, the step correlation module correlates vertical acceleration with horizontal acceleration shifted (by the step shifter) by one quarter step both forwards and backwards (e.g., +/−90 degrees).

After shifting and correlation as described above, the vertical/forward correlation may be comparatively strong due to the biomechanics of pedestrian motion, while the vertical/transverse correlation may be approximately zero. Thus, the correlations between vertical and horizontal acceleration shifted forward and backward by one quarter step are computed, and the forward shifted result may be subtracted from the backward shifted result (since the results of the two correlations are opposite in sign) to further reduce the transverse component of acceleration.

After the motion direction tracking module substantially cancels transverse acceleration as discussed above, the alignment angle computation module determines the angle between the forward component of acceleration and the orientation of the mobile device 302. According to aspects of the present disclosure, the alignment angle computation module may include an Eigen analysis module and an angle direction inference module (not shown). In one exemplary implementation, the alignment angle computation module identifies the misalignment angle via Eigen analysis, as performed by an Eigen analysis module, and further processing performed by an angle direction inference module. Based on information provided by the motion direction tracking module, the Eigen analysis module determines the orientation of the sensor axes of the mobile device 302 with respect to the earth, from which a line corresponding to the direction of motion of the mobile device 302 is obtained. The angle direction inference module analyzes the obtained line, as well as forward and vertical acceleration data corresponding to the corresponding pedestrian step(s), to determine the direction of the misalignment angle based on the direction of motion of the mobile device 302 (e.g., forward or backward along the obtained line). By doing so, the angle direction inference module operates to resolve forward/backward ambiguity associated with the misalignment angle.

According to aspects of the present disclosure, the angle direction inference module leverages the motion signature of a pedestrian step to determine the direction of the misalignment angle. As discussed above, forward and vertical acceleration corresponding to a pedestrian step are related due to the mechanics of leg rotation, body movement, and other factors associated with pedestrian motion. Thus, the angle direction inference module can be configured to utilize knowledge of these relationships to identify whether a motion direction is forward or backward along a given line.

While the above discussion relates to obtaining a two-dimensional motion direction, e.g., with respect to a horizontal plane, similar techniques may be utilized to obtain a direction of motion in three dimensions. Thus, the techniques described herein can be extended to account for changes in altitude, pedestrian motion along an uneven surface, and/or other factors impacting the direction of motion in three dimensions.

Additionally, the techniques described above can be extended to leverage a gyroscope in addition to accelerometer(s). With further reference to the biomechanics of pedestrian motion, leg rotation and other associated movements during a pedestrian step can be classified as angular movements, e.g., measured in terms of pitch or roll. Accordingly, a gyroscope can be used to separate gravity from acceleration due to movement such that the reference frame for computation can be rotated to account for the orientation of the mobile device 302 prior to the calculations described above.

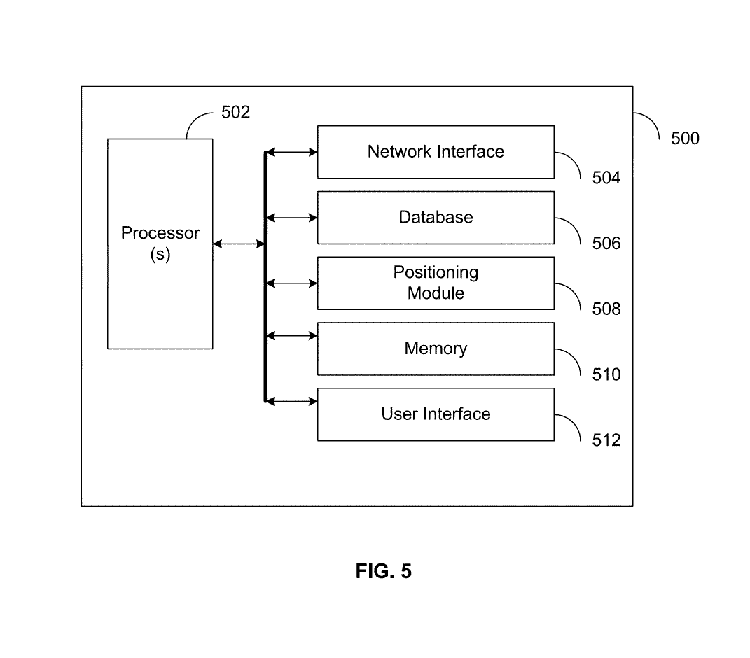

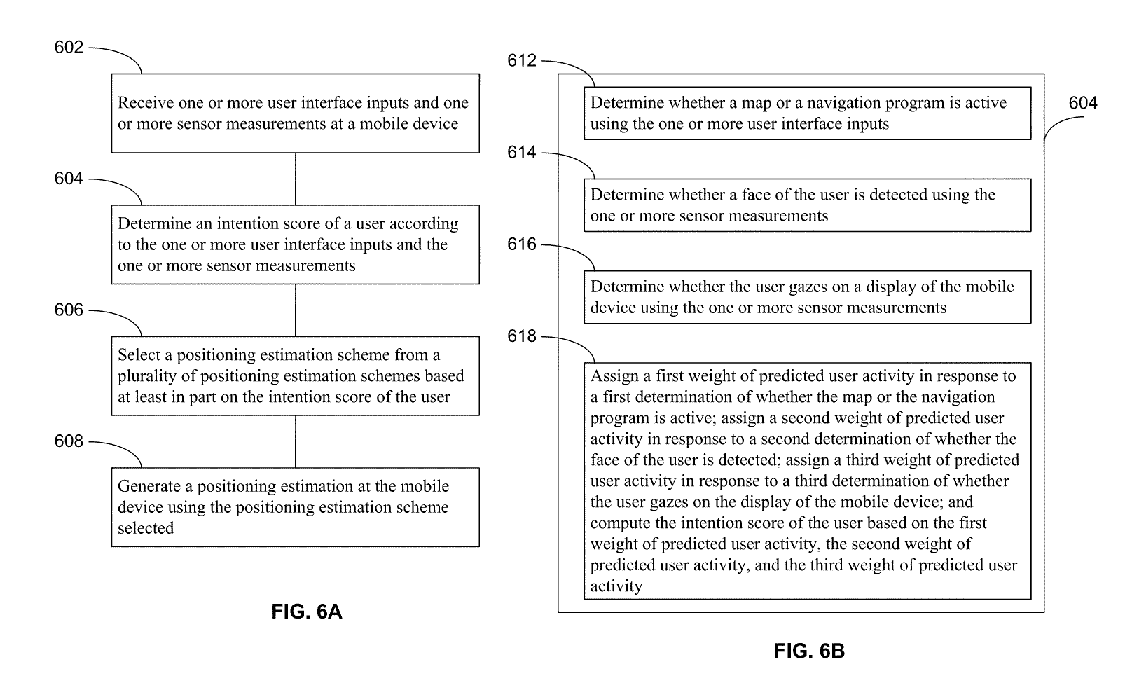

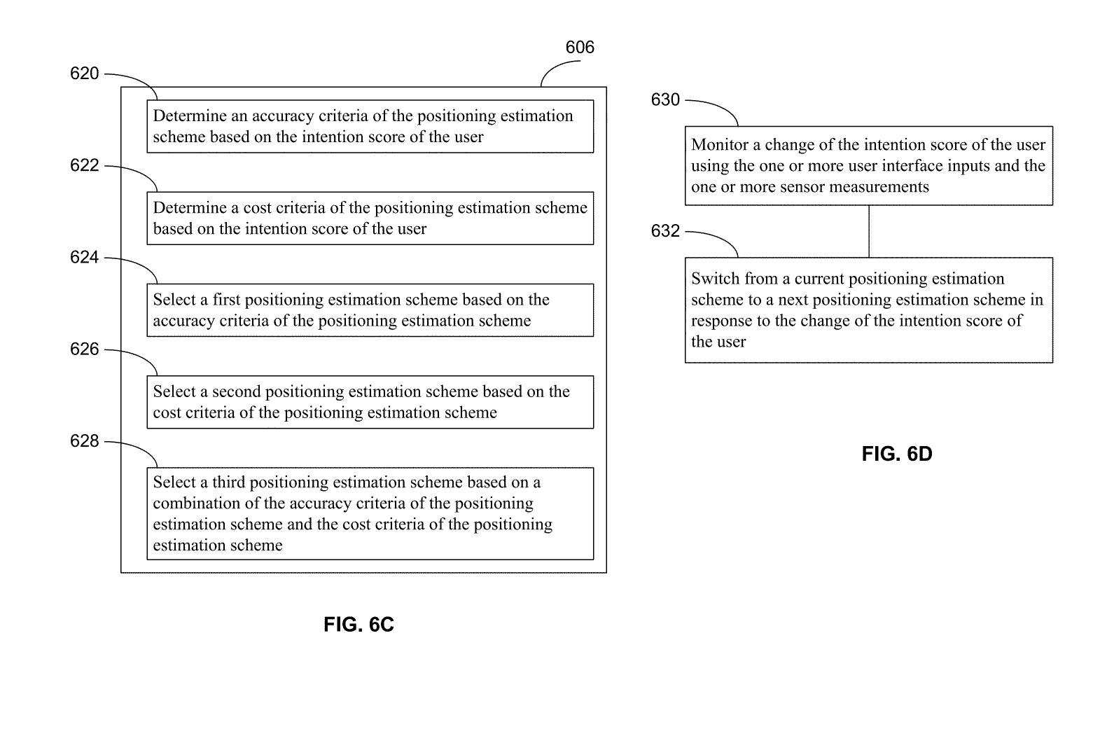

FIG. 5 illustrates an exemplary apparatus for configuring positioning estimations dynamically according to aspects of the present disclosure. In the example shown in FIG. 5, apparatus 500 may include one or more processors 502, network interface 504, database 506, positioning module 508, memory 510, and user interface 512. The one or more processors 502 can be configured to control operations of the apparatus 500. The network interface 504 can be configured to communicate with a network (not shown), which may be configured to communicate with servers, computers, and mobile devices on the network. Database 506 can be configured to store sensor measurements, user interface inputs, intention scores, positioning estimations, images, and other information related to dynamically configuring positioning estimations of a mobile device. The one or more processors 502 and/or the positioning module 508 can be configured to implement methods of configuring positioning estimations dynamically. For example, working with the processor(s) 502, the positioning module 508 can be configured to implement methods described in association with FIG. 1 to FIG. 4A-4B, and FIG. 6A-6D. Memory 510 can be configured to store program codes, instructions, and data for the apparatus 500. User interface 512 may be configured to enable interactions between apparatus 500 and a user. According to aspects of the present disclosure, the apparatus 500 may be implemented as a part of a server. In that implementation, the positioning assistance data or positioning estimates may be communicated to mobile devices via the network interface 504. According to other aspects of the present disclosure, the apparatus 500 may be implemented as a part of a mobile device. In that implementation, the positioning assistance data or positioning estimates may be used by the mobile device and/or may be communicated to other mobile devices or servers via the network interface 504. In yet other implementations, some blocks of the apparatus 500 may be implemented in a mobile device and some blocks of the apparatus 500 may be in a server. These implementations or any combinations thereof are within the scope of the present disclosure.

FIG. 6A illustrates an exemplary flow chart for implementing methods of configuring positioning estimations dynamically according to aspects of the present disclosure. In the exemplary implementation shown in FIG. 6A, in block 602, the method receives one or more user interface inputs and one or more sensor measurements at a mobile device. In block 604, the method determines an intention score of a user according to the one or more user interface inputs and the one or more sensor measurements. In block 606, the method selects a positioning estimation scheme from a plurality of positioning estimation schemes based at least in part on the intention score of the user. In block 608, the method generates a positioning estimation at the mobile device using the positioning estimation scheme selected.

According to aspects of the present disclose, the methods performed in block 604 may further include the methods performed in block 612, block 614, block 616, block 618, or any combinations of two or more blocks from 612 to 618. FIG. 6B illustrates an exemplary implementation for determining an intention score of a user according to aspects of the present disclosure. As shown in FIG. 6B, in block 612, the method determines whether a map or a navigation program is active using the one or more user interface inputs. In block 614, the method determines whether a face of the user is detected using the one or more sensor measurements. In block 616, the method determines whether the user gazes on a display of the mobile device using the one or more sensor measurements. In block 618, the method assigns a first weight of predicted user activity in response to a first determination of whether the map or the navigation program is active; assigns a second weight of predicted user activity in response to a second determination of whether the face of the user is detected; assigns a third weight of predicted user activity in response to a third determination of whether the user gazes on the display of the mobile device; and computes the intention score of the user based on the first weight of predicted user activity, the second weight of predicted user activity, and the third weight of predicted user activity.

FIG. 6C illustrates an exemplary implementation for selecting a positioning estimation scheme according to aspects of the present disclosure. In some embodiments, the methods performed in block 606 may further include the methods performed in block 620, block 622, block 624, block 626, block 628, or any combinations of two or more blocks from 620 to 628. In the example shown in FIG. 6C, in block 620, the method determines an accuracy criteria of the positioning estimation scheme based on the intention score of the user. In block 622, the method determines cost criteria of the positioning estimation scheme based on the intention score of the user. In block 624, the method selects a first positioning estimation scheme based on the accuracy criteria of the positioning estimation scheme. In block 626, the method selects a second positioning estimation scheme based on the cost criteria of the positioning estimation scheme. In block 628, the method selects a third positioning estimation scheme based on a combination of the accuracy criteria of the positioning estimation scheme and the cost criteria of the positioning estimation scheme. The third positioning estimation scheme may be a combination of a particle filter based positioning estimation scheme and a pedometer based positioning estimation scheme.

FIG. 6D illustrates another exemplary implementation for configuring positioning estimations dynamically according to aspects of the present disclosure. In the exemplary implementation shown in FIG. 6D, in block 630, the method monitors a change of the intention score of the user using the one or more user interface inputs and the one or more sensor measurements. In block 632, the method switches from a current positioning estimation scheme to a next positioning estimation scheme in response to the change of the intention score of the user.

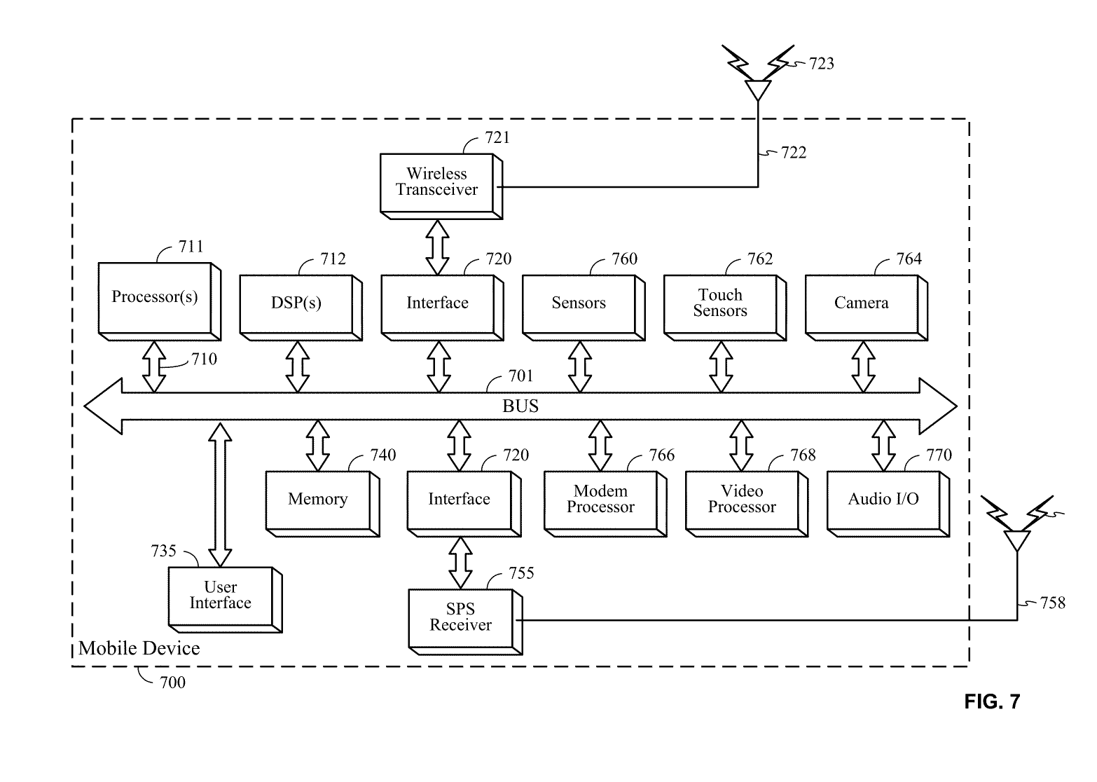

FIG. 7 illustrates an exemplary block diagram of a mobile device according to aspects of the present disclosure. As shown in FIG. 7, mobile device 700 may comprise one or more features of the one or more mobile devices (such as mobile device 302 of FIG. 3A and FIG. 3B, and apparatus 500 of FIG. 5) as described in association with FIG. 1 to FIG. 6A-6D. In certain embodiments, mobile device 700 may also comprise a wireless transceiver 721 which is capable of transmitting and receiving wireless signals 723 via wireless antenna 722 over a wireless communication network. Wireless transceiver 721 may be connected to bus 701 by a wireless transceiver bus interface 720. Wireless transceiver bus interface 720 may, in some embodiments be at least partially integrated with wireless transceiver 721. Some embodiments may include multiple wireless transceivers 721 and wireless antennas 722 to enable transmitting and/or receiving signals according to a corresponding multiple wireless communication standards such as, for example, versions of IEEE Std. 802.11, CDMA, WCDMA, LTE, UMTS, GSM, AMPS, Zigbee and Bluetooth, etc.

According to aspects of the present disclosure, wireless transceiver 721 may comprise a transmitter and a receiver. The transmitter and the receiver may be implemented to share common circuitry, or may be implemented as separate circuits. Mobile device 700 may also comprise SPS receiver 755 capable of receiving and acquiring SPS signals 759 via SPS antenna 758. SPS receiver 755 may also process, in whole or in part, acquired SPS signals 759 for estimating a location of mobile device 700. In some embodiments, processor(s) 711, memory 740, DSP(s) 712 and/or specialized processors (not shown) may also be utilized to process acquired SPS signals, in whole or in part, and/or calculate an estimated location of mobile device 700, in conjunction with SPS receiver 755. Storage of SPS or other signals for use in performing positioning operations may be performed in memory 740 or registers (not shown).

Also shown in FIG. 7, mobile device 700 may comprise digital signal processor(s) (DSP(s)) 712 connected to the bus 701 by a bus interface 710, processor(s) 711 connected to the bus 701 by a bus interface 710 and memory 740. Bus interface 710 may be integrated with the DSP(s) 712, processor(s) 711 and memory 740. In various embodiments, functions may be performed in response execution of one or more machine-readable instructions stored in memory 740 such as on a computer-readable storage medium, such as RAM, ROM, FLASH, or disc drive, just to name a few example. The one or more instructions may be executable by processor(s) 711, specialized processors, or DSP(s) 712. Memory 740 may comprise a non-transitory processor-readable memory and/or a computer-readable memory that stores software code (programming code, instructions, etc.) that are executable by processor(s) 711 and/or DSP(s) 712 to perform functions described herein. In a particular implementation, wireless transceiver 721 may communicate with processor(s) 711 and/or DSP(s) 712 through bus 701 to enable mobile device 700 to be configured as a wireless mobile device as discussed above. Processor(s) 711 and/or DSP(s) 712 may execute instructions to execute one or more aspects of processes/methods discussed above in connection with FIG. 6A-6D.

Also shown in FIG. 7, a user interface 735 may comprise any one of several devices such as, for example, a speaker, microphone, display device, vibration device, keyboard, touch screen, etc. In a particular implementation, user interface 735 may enable a user to interact with one or more applications hosted on mobile device 700. For example, devices of user interface 735 may store analog or digital signals on memory 740 to be further processed by DSP(s) 712 or processor 711 in response to action from a user. Similarly, applications hosted on mobile device 700 may store analog or digital signals on memory 740 to present an output signal to a user. In another implementation, mobile device 700 may optionally include a dedicated audio input/output (I/O) device 770 comprising, for example, a dedicated speaker, microphone, digital to analog circuitry, analog to digital circuitry, amplifiers and/or gain control. In another implementation, mobile device 700 may comprise touch sensors 762 responsive to touching or pressure on a keyboard or touch screen device.

Mobile device 700 may also comprise a dedicated camera device 764 for capturing still or moving imagery. Dedicated camera device 764 may comprise, for example an imaging sensor (e.g., charge coupled device or CMOS imager), lens, analog to digital circuitry, frame buffers, etc. In one implementation, additional processing, conditioning, encoding or compression of signals representing captured images may be performed at processor 711 or DSP(s) 712. Alternatively, a dedicated video processor 768 may perform conditioning, encoding, compression or manipulation of signals representing captured images. Additionally, dedicated video processor 768 may decode/decompress stored image data for presentation on a display of mobile device 700.

Mobile device 700 may also comprise sensors 760 coupled to bus 701 which may include, for example, inertial sensors and environment sensors. Inertial sensors of sensors 760 may comprise, for example accelerometers (e.g., collectively responding to acceleration of mobile device 700 in three dimensions), one or more gyroscopes or one or more magnetometers (e.g., to support one or more compass applications). Environment sensors of mobile device 700 may comprise, for example, temperature sensors, barometric pressure sensors, ambient light sensors, and camera imagers, microphones, just to name few examples. Sensors 760 may generate analog or digital signals that may be stored in memory 740 and processed by DPS(s) or processor 711 in support of one or more applications such as, for example, applications directed to positioning or navigation operations.

In a particular implementation, mobile device 700 may comprise a dedicated modem processor 766 capable of performing baseband processing of signals received and down-converted at wireless transceiver 721 or SPS receiver 755. Similarly, dedicated modem processor 766 may perform baseband processing of signals to be up-converted for transmission by wireless transceiver 721. In alternative implementations, instead of having a dedicated modem processor, baseband processing may be performed by a processor or DSP (e.g., processor 711 or DSP(s) 712).

The methodologies described herein may be implemented by various means depending upon applications according to particular examples. For example, such methodologies may be implemented in hardware, firmware, software, or combinations thereof. In a hardware implementation, for example, a processing unit may be implemented within one or more application specific integrated circuits (“ASICs”), digital signal processors (“DSPs”), digital signal processing devices (“DSPDs”), programmable logic devices (“PLDs”), field programmable gate arrays (“FPGAs”), processors, controllers, micro-controllers, microprocessors, electronic devices, other devices units designed to perform the functions described herein, or combinations thereof.

Some portions of the detailed description included herein are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular operations pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer, special purpose computing apparatus or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Wireless communication techniques described herein may be in connection with various wireless communications networks such as a wireless wide area network (“WWAN”), a wireless local area network (“WLAN”), a wireless personal area network (WPAN), and so on. The term “network” and “system” may be used interchangeably herein. A WWAN may be a Code Division Multiple Access (“CDMA”) network, a Time Division Multiple Access (“TDMA”) network, a Frequency Division Multiple Access (“FDMA”) network, an Orthogonal Frequency Division Multiple Access (“OFDMA”) network, a Single-Carrier Frequency Division Multiple Access (“SC-FDMA”) network, or any combination of the above networks, and so on. A CDMA network may implement one or more radio access technologies (“RATs”) such as cdma2000, Wideband-CDMA (“W-CDMA”), to name just a few radio technologies. Here, cdma2000 may include technologies implemented according to IS-95, IS-2000, and IS-856 standards. A TDMA network may implement Global System for Mobile Communications (“GSM”), Digital Advanced Mobile Phone System (“D-AMPS”), or some other RAT. GSM and W-CDMA are described in documents from a consortium named “3rd Generation Partnership Project” (“3GPP”). Cdma2000 is described in documents from a consortium named “3rd Generation Partnership Project 2” (“3GPP2”). 3GPP and 3GPP2 documents are publicly available. 4G Long Term Evolution (“LTE”) communications networks may also be implemented in accordance with claimed subject matter, in an aspect. A WLAN may comprise an IEEE 802.11x network, and a WPAN may comprise a Bluetooth network, an IEEE 802.15x, for example. Wireless communication implementations described herein may also be used in connection with any combination of WWAN, WLAN or WPAN.

In another aspect, as previously mentioned, a wireless transmitter or access point may comprise a femtocell, utilized to extend cellular telephone service into a business or home. In such an implementation, one or more mobile devices may communicate with a femtocell via a code division multiple access (“CDMA”) cellular communication protocol, for example, and the femtocell may provide the mobile device access to a larger cellular telecommunication network by way of another broadband network such as the Internet.

Techniques described herein may be used with an SPS that includes any one of several GNSS and/or combinations of GNSS. Furthermore, such techniques may be used with positioning systems that utilize terrestrial transmitters acting as “pseudolites”, or a combination of SVs and such terrestrial transmitters. Terrestrial transmitters may, for example, include ground-based transmitters that broadcast a PN code or other ranging code (e.g., similar to a GPS or CDMA cellular signal). Such a transmitter may be assigned a unique PN code so as to permit identification by a remote receiver. Terrestrial transmitters may be useful, for example, to augment an SPS in situations where SPS signals from an orbiting SV might be unavailable, such as in tunnels, mines, buildings, urban canyons or other enclosed areas. Another implementation of pseudolites is known as radio-beacons. The term “SV”, as used herein, is intended to include terrestrial transmitters acting as pseudolites, equivalents of pseudolites, and possibly others. The terms “SPS signals” and/or “SV signals”, as used herein, is intended to include SPS-like signals from terrestrial transmitters, including terrestrial transmitters acting as pseudolites or equivalents of pseudolites.

The terms, “and,” and “or” as used herein may include a variety of meanings that will depend at least in part upon the context in which it is used. Typically, “or” if used to associate a list, such as A, B or C, is intended to mean A, B, and C, here used in the inclusive sense, as well as A, B or C, here used in the exclusive sense. Reference throughout this specification to “one example” or “an example” means that a particular feature, structure, or characteristic described in connection with the example is included in at least one example of claimed subject matter. Thus, the appearances of the phrase “in one example” or “an example” in various places throughout this specification are not necessarily all referring to the same example. Furthermore, the particular features, structures, or characteristics may be combined in one or more examples. Examples described herein may include machines, devices, engines, or apparatuses that operate using digital signals. Such signals may comprise electronic signals, optical signals, electromagnetic signals, or any form of energy that provides information between locations.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all aspects falling within the scope of the appended claims, and equivalents thereof.

What is claimed is:

1. A method of configuring positioning estimations dynamically, comprising:
receiving one or more user interface inputs and one or more sensor measurements at a mobile device;
determining an intention score of a user according to the one or more user interface inputs and the one or more sensor measurements;
selecting a positioning estimation scheme from a plurality of positioning estimation schemes based at least in part on the intention score of the user; and
generating a positioning estimation at the mobile device using the positioning estimation scheme selected.

2. The method of claim 1, wherein the determining the intention score of the user comprises at least one of:
determining whether a map or a navigation program is active using the one or more user interface inputs;
determining whether a face of the user is detected using the one or more sensor measurements; or
determining whether the user gazes on a display of the mobile device using the one or more sensor measurements.

3. The method of claim 2, wherein the determining the intention score of the user further comprises:
assigning a first weight of predicted user activity in response to a first determination of whether the map or the navigation program is active;
assigning a second weight of predicted user activity in response to a second determination of whether the face of the user is detected;
assigning a third weight of predicted user activity in response to a third determination of whether the user gazes on the display of the mobile device; and
computing the intention score of the user based on the first weight of predicted user activity, the second weight of predicted user activity, and the third weight of predicted user activity.

4. The method of claim 1, wherein the selecting the positioning estimation scheme from the plurality of positioning estimation schemes comprises at least one of:
determining an accuracy criteria of the positioning estimation scheme based on the intention score of the user; or
determining a cost criteria of the positioning estimation scheme based on the intention score of the user.

5. The method of claim 4, further comprising at least one of:
selecting a first positioning estimation scheme based on the accuracy criteria of the positioning estimation scheme;
selecting a second positioning estimation scheme based on the cost criteria of the positioning estimation scheme; or
selecting a third positioning estimation scheme based on a combination of the accuracy criteria of the positioning estimation scheme and the cost criteria of the positioning estimation scheme.

6. The method of claim 5, wherein the third positioning estimation scheme is a combination of a particle filter based positioning estimation scheme and a pedometer based positioning estimation scheme.

7. The method of claim 1, further comprising:
monitoring a change of the intention score of the user using the one or more user interface inputs and the one or more sensor measurements; and
switching from a current positioning estimation scheme to a next positioning estimation scheme in response to the change of the intention score of the user.

8. An apparatus, comprising:
one or more user input mechanisms;
one or more sensors; and
one or more processors to:
receive one or more user interface inputs via the one or more user input mechanisms;
receive one or more sensor measurements from the one or more sensors;
determine an intention score of a user according to the one or more user interface inputs and the one or more sensor measurements;
select a positioning estimation scheme from a plurality of positioning estimation schemes based, at least in part, on the intention score of the user; and
generate a positioning estimation at the apparatus using the positioning estimation scheme selected.

9. The apparatus of claim 8, wherein the one or more processors to determine at least one of:
whether a map or a navigation program is active using the one or more user interface inputs;
whether a face of the user is detected using the one or more sensor measurements; or
whether the user gazes on a display of the apparatus using the one or more sensor measurements.

10. The apparatus of claim 9, wherein the one or more processors to further:
assign a first weight of predicted user activity in response to a first determination of whether the map or the navigation program is active;
assign a second weight of predicted user activity in response to a second determination of whether the face of the user is detected;
assign a third weight of predicted user activity in response to a third determination of whether the user gazes on the display of the apparatus; and
compute the intention score of the user based on the first weight of predicted user activity, the second weight of predicted user activity, and the third weight of predicted user activity.

11. The apparatus of claim 8, wherein the one or more processors to determine at least one of:
an accuracy criteria of the positioning estimation scheme based on the intention score of the user; or
a cost criteria of the positioning estimation scheme based on the intention score of the user.

12. The apparatus of claim 11, wherein the one or more processors to select at least one of:
a first positioning estimation scheme based on the accuracy criteria of the positioning estimation scheme;
a second positioning estimation scheme based on the cost criteria of the positioning estimation scheme; or
a third positioning estimation scheme based on a combination of the accuracy criteria of the positioning estimation scheme and the cost criteria of the positioning estimation scheme.

13. The apparatus of claim 12, wherein the third positioning estimation scheme is a combination of a particle filter based positioning estimation scheme and a pedometer based positioning estimation scheme.

14. The apparatus of claim 8, wherein the one or more processors to further:
monitor a change of the intention score of the user using the one or more user interface inputs and the one or more sensor measurements; and
switch from a current positioning estimation scheme to a next positioning estimation scheme in response to the change of the intention score of the user.

15. A computer program product comprising non-transitory medium storing instructions for execution by one or more computer systems, the instructions comprising:
instructions for receiving one or more user interface inputs and one or more sensor measurements at a mobile device;
instructions for determining an intention score of a user according to the one or more user interface inputs and the one or more sensor measurements;
instructions for selecting a positioning estimation scheme from a plurality of positioning estimation schemes based at least in part on the intention score of the user; and
instructions for generating a positioning estimation at the mobile device using the positioning estimation scheme selected.

16. The computer program product of claim 15, wherein the instructions for determining the intention score of the user comprises at least one of:
instructions for determining whether a map or a navigation program is active using the one or more user interface inputs;
instructions for determining whether a face of the user is detected using the one or more sensor measurements; or
instructions for determining whether the user gazes on a display of the mobile device using the one or more sensor measurements.

17. The computer program product of claim 16, wherein the instructions for determining the intention score of the user further comprises:
instructions for assigning a first weight of predicted user activity in response to a first determination of whether the map or the navigation program is active;
instructions for assigning a second weight of predicted user activity in response to a second determination of whether the face of the user is detected;
instructions for assigning a third weight of predicted user activity in response to a third determination of whether the user gazes on the display of the mobile device; and
instructions for computing the intention score of the user based on the first weight of predicted user activity, the second weight of predicted user activity, and the third weight of predicted user activity.

18. The computer program product of claim 15, wherein the instructions for selecting the positioning estimation scheme from the plurality of positioning estimation schemes comprises at least one of:
instructions for determining an accuracy criteria of the positioning estimation scheme based on the intention score of the user; or
instructions for determining a cost criteria of the positioning estimation scheme based on the intention score of the user.

19. The computer program product of claim 18, further comprising at least one of:
instructions for selecting a first positioning estimation scheme based on the accuracy criteria of the positioning estimation scheme;
instructions for selecting a second positioning estimation scheme based on the cost criteria of the positioning estimation scheme; or
instructions for selecting a third positioning estimation scheme based on a combination of the accuracy criteria of the positioning estimation scheme and the cost criteria of the positioning estimation scheme, wherein the third positioning estimation scheme is a combination of a particle filter based positioning estimation scheme and a pedometer based positioning estimation scheme.

20. The computer program product of claim 15, further comprising:
instructions for monitoring a change of the intention score of the user using the one or more user interface inputs and the one or more sensor measurements; and
instructions for switching from a current positioning estimation scheme to a next positioning estimation scheme in response to the change of the intention score of the user.
